(19) United States
(12) Patent Application Publication
(10) Pub. No.: US 2022/0036591 A1
(43) Pub. Date: Feb. 3, 2022

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Hiroyasu Ito, Tokyo (JP)

(21) Appl. No.: 17/369,996

(22) Filed: Jul. 8, 2021

(30) Foreign Application Priority Data
Jul. 31, 2020 (JP) 2020-130504

(51) Int. Cl. G06T 7/90; G06T 7/00

(52) U.S. Cl. CPC G06T 7/90; G06T 2207/20224; G06T 7/97

(57) ABSTRACT

With an image processing apparatus, a captured image to be used for obtaining color information of an object is specified based on a designated virtual viewpoint from among multiple captured images obtained by capturing images of the object from different positions. Color information of the object in a virtual viewpoint image is determined based on the color information of the object obtained from the specified captured image. The virtual viewpoint image is generated based on the determined color information of the object. In a case where a structure occluding the object is included in the specified captured image, a captured image that is different from the specified captured image is specified as the captured image to be used for obtaining the color information of the object, based on color information of the structure.

### FIELD

The present disclosure relates to a technology for generating a virtual viewpoint image.

### DESCRIPTION OF THE RELATED ART

There is a technology to generate three-dimensional shape data of an object by use of captured images from multiple directions which are obtained by synchronous image-capturing by multiple image capturing devices, in order to perform processing such as rendering (coloring) so as to generate a virtual viewpoint image representing a scene of viewing the object from a given viewpoint. According to the generation technology of this virtual viewpoint image, for example, highlight scenes of soccer or basketball can be viewed from various angles, so that it is possible to give a user a highly realistic feeling, compared with normal video images.

As a method of coloring an object at the time of generating a virtual viewpoint image, Japanese Patent Laid-Open No. 2016-126425 discloses such a technology with which the color weight of an image of a camera is increased according to the proximity of a direction relative to a virtual viewpoint for coloring each part or with which the coloring is performed by use of an image of a camera that is close to the virtual viewpoint.

### SUMMARY

Depending on the virtual viewpoint, there is a case where a captured image of an image capturing device with a structure occluding an object in the image capturing direction is used, and, in this captured image, the coloring-target pixel of the object at the time of generating a virtual viewpoint image overlaps the structure. In such a case, with the technology of Japanese Patent Laid-Open No. 2016-126425, there is a possibility that the object at the time of generating the virtual viewpoint image is colored by use of the color information of the structure.

For example, in a case of being applied to generation of a virtual viewpoint image of a shooting scene in a soccer game, there is a possibility that a goalkeeper at the time of generating the virtual viewpoint image is undesirably colored by use of the color information of a soccer goal net, not the color information of the goalkeeper, depending on the virtual viewpoint. This is because there is a case where, from among captured images with the goalkeeper, a captured image in which the goalkeeper appears across the goal net is used, and the coloring-target pixel of the goalkeeper at the time of generating the virtual viewpoint image overlaps the goal net in the captured image.

The present disclosure provides a technology for appropriately determining the color information of an object at the time of generating a virtual viewpoint image.

An image processing apparatus according to an embodiment of the present disclosure specifies a captured image to be used for obtaining color information of an object, based on a designated virtual viewpoint, from among a plurality of captured images obtained by a plurality of image capturing units that capture the object from different positions; determines color information of the object in a virtual viewpoint image, based on the color information of the object obtained from the captured image specified in the specifying; and generates the virtual viewpoint image, based on the color information of the object determined in the determining, wherein, in the specifying, in a case where a structure occluding the object is included in the specified captured image, a captured image that is different from the specified captured image is specified as the captured image to be used for obtaining the color information of the object, based on color information of the structure.

Further features of the present disclosure will become apparent from the following description of exemplary embodiments with reference to the attached drawings.

### BRIEF DESCRIPTION OF THE DRAWINGS

FIG. 1 is a diagram illustrating a configuration example of an image processing system;

FIG. 2 is a diagram illustrating a hardware configuration example of the image processing apparatus;

FIG. 3 is a block diagram illustrating a functional configuration example of the image processing apparatus;

FIG. 4A and FIG. 4B are diagrams for explaining a coloring method;

FIG. 5A and FIG. 5B are diagrams illustrating examples of a captured image of an image capturing device;

FIG. 6 is a flowchart illustrating a flow of processing executed by the image processing apparatus;

FIG. 7A and FIG. 7B are diagrams for explaining a method for determining a prohibited color;

FIG. 8A to FIG. 8C are diagrams for explaining a method for determining a prohibited color by use of prohibited color patterns;

FIG. 9 is a diagram illustrating an example of a captured image of an image capturing device;

FIG. 10 is a diagram illustrating an example of a captured image of an image capturing device in which a structure having color information whose color difference from a dynamic object is relatively large appears;

FIG. 11A to FIG. 11D are diagrams illustrating examples of a captured image and examples of a mask image;

FIG. 12 is a block diagram illustrating a functional configuration example of an image processing apparatus;

FIG. 13 is a flowchart illustrating a flow of processing executed by the image processing apparatus; and

FIG. 14 is a diagram illustrating an example of a captured image in a state where a dynamic object is not occluded by a structure.

### DESCRIPTION OF THE EMBODIMENTS

Hereinafter, modes for carrying out the present disclosure will be explained with reference to the drawings. Note that the components described in these embodiments are merely examples, and it is not intended that the scope of the present disclosure is limited thereto. Further, every combination of the components explained in the embodiments is not necessarily essential to the solution for solving the problems, and various transformations and modifications are possible. The same reference sign is assigned for explanations of the same configuration. In the present specification, trailing alphabets of reference signs are used for identifying individual configurations in similar configurations. In a case where a trailing alphabet is omitted in a description, it is assumed that the description is given without particularly distinguishing individual configurations.

### First Embodiment

<System Configuration>

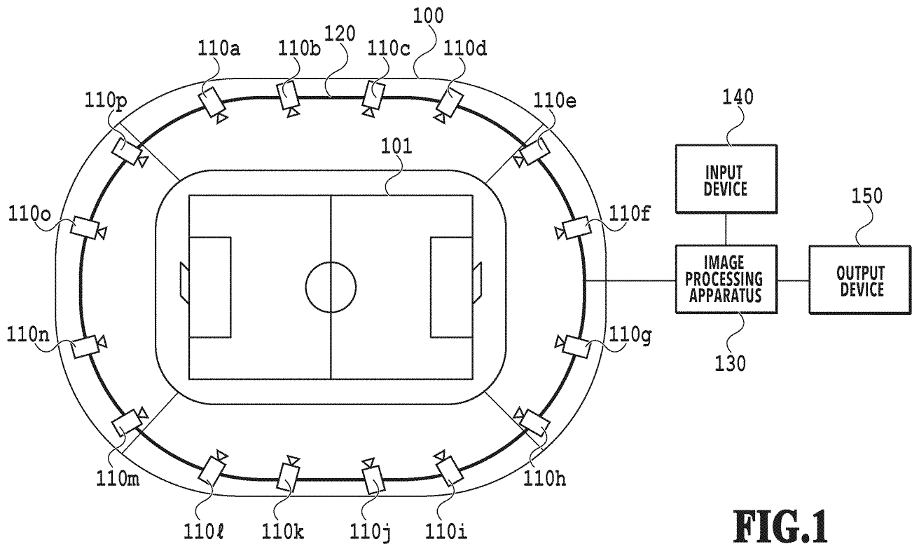

An explanation will be given of a mode in which, in a case where a structure occluding a dynamic object is included in a captured image, the color information obtained from the captured image is compared with prohibited color information which is set based on the color information of the structure, and the dynamic object at the time of generating a virtual viewpoint image is colored by use of the color information according to the comparison result. In the present embodiment, the example in which an image processing system according to an embodiment of the present disclosure is applied to the creation of a virtual viewpoint image of a soccer game will be explained with reference to the drawings. FIG. 1 is a diagram illustrating a configuration example of an image processing system for generating a virtual viewpoint image according to the present embodiment. The image processing system is a system for generating a virtual viewpoint image representing the perception from a designated virtual viewpoint, based on multiple captured images that are obtained by image-capturing by multiple image capturing devices and information of the designated virtual viewpoint. The virtual viewpoint image in the present embodiment is also referred to as a free viewpoint video image but is not limited to an image corresponding to a viewpoint (virtual viewpoint) freely (arbitrarily) specified by the user, and, for example, an image corresponding to a viewpoint selected by the user from among multiple candidates, etc., is included as the virtual viewpoint image. Further, although the case in which the virtual viewpoint is designated by a user operation will be mainly explained in the present embodiment, it is also possible that the virtual viewpoint is automatically designated based on a result of image analysis or the like. Further, although the case in which the virtual viewpoint image is a moving image will be mainly explained in the present embodiment, it is also possible that the virtual viewpoint image is a still image.

As illustrated in FIG. 1, the image processing system includes the multiple image capturing devices 110a to 110p, the image processing apparatus 130, the input device 140, and the output device 150.

The multiple image capturing devices 110a to 110p are respectively installed at different positions so as to surround the field 101, which is an image capturing area in the stadium 100 where a competition is held, so that image-capturing of the image capturing area is performed in a synchronous manner from multiple directions. Note that the multiple image capturing devices 110a to 110p may not be installed over the entire circumference of the image capturing area and may be installed only in a partial direction of the image capturing area, depending on limitations on the installation locations or the like. Further, the number of image capturing devices 110 is not limited to 16 and may be less or more than 16, such as about 100, for example. Further, as the multiple image capturing devices 110, image capturing devices having different functions such as a telephoto camera and a wide-angle camera may coexist. The image capturing devices 110a to 110p are connected to the image processing apparatus 130 via the network 120, and the captured images obtained in the image-capturing by the image capturing devices 110 are transmitted to the selection unit 302 and the setting unit 303 of the image processing apparatus 130, which will be described in detail later. The input device 140 and the output device 150 are connected to the image processing apparatus 130.

The input device 140 is an information processing device such as a computer including a mouse, keyboard, touchscreen, etc., that accepts an operation instruction or input of various kinds of setting information by the user provided to the determination unit 301 of the image processing apparatus 130. The various kinds of setting information include, for example, information about a virtual viewpoint, etc. The information about a virtual viewpoint (also referred to as the information of a virtual viewpoint) is viewpoint information to be used for generating a virtual viewpoint image and is information indicating the position and orientation of the virtual viewpoint. Specifically, the viewpoint information is a parameter set including a parameter representing the three-dimensional position of the virtual viewpoint and a parameter representing the orientation of the virtual viewpoint in the pan, tilt, and roll directions. Note that the contents of the viewpoint information is not limited to the above. For example, the parameter set as the viewpoint information may include a parameter representing the size (angle of view) of the field of view of the virtual viewpoint. Further, the viewpoint information may have multiple parameter sets. For example, the viewpoint information may have multiple parameter sets respectively corresponding to multiple frames configuring a moving image of the virtual viewpoint image, so as to be information indicating the position and orientation of the virtual viewpoint at each of the consecutive multiple time points.

The output device 150 is a display device, such as a liquid crystal display, that displays and outputs various kinds of setting information and image data, such as a virtual viewpoint image created by the image processing apparatus 130 and captured images obtained in image-capturing by the multiple image capturing devices 110a to 110p, so as to be viewable and browsable for the user.

<Hardware Configuration of Image Processing Apparatus>

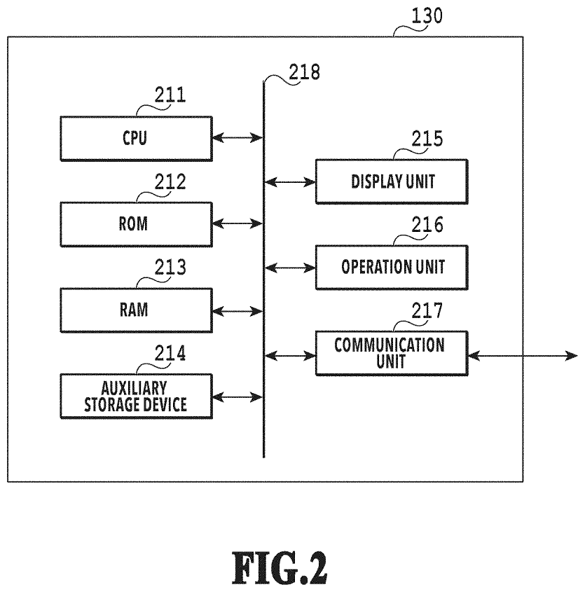

The hardware configuration of the image processing apparatus 130 will be explained with reference to the drawings. FIG. 2 is a block diagram illustrating a hardware configuration example of the image processing apparatus 130. As illustrated in FIG. 2, the image processing apparatus 130 includes the CPU 211, the ROM 212, the RAM 213, the auxiliary storage device 214, the display unit 215, the operation unit 216, the communication unit 217, and the bus 218.

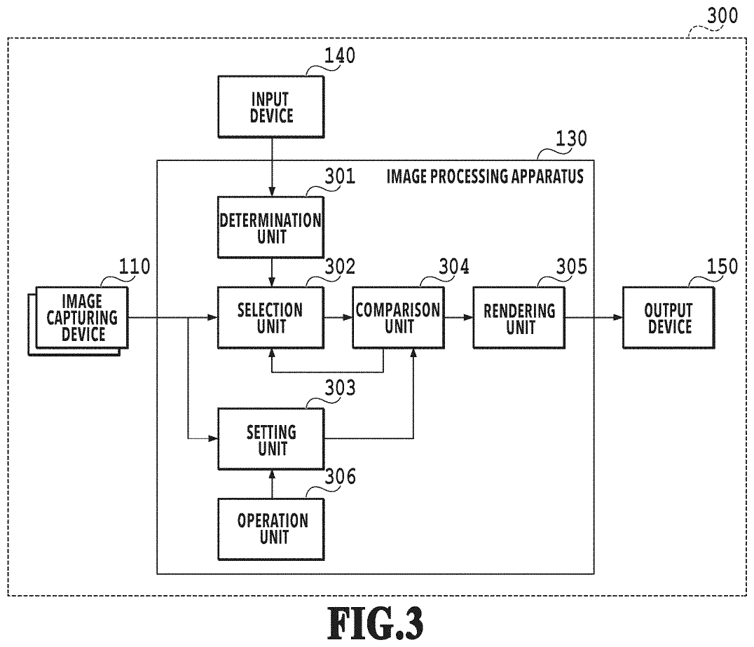

The CPU 211 controls the entire image processing apparatus 130 by use of a computer program and data stored in the ROM 212 or the RAM 213, so as to implement each function of the image processing apparatus 130 illustrated in FIG. 3. Note that the image processing apparatus 130 may include one or more dedicated hardware other than the CPU 211, so that the dedicated hardware executes at least a part of the processing performed by the CPU 211. Examples of dedicated hardware include an ASIC (Application Specific Integrated Circuit), an FPGA (Field-Programmable Gate Array), a DSP (Digital Signal Processor), and the like. The ROM 212 stores programs that need not be changed, etc. The RAM 213 temporarily stores data or a program supplied from the auxiliary storage device 214, data supplied from the outside via the communication unit 217, or the like. The auxiliary storage device 214 is configured with, for example, a hard disk drive, etc., and stores various kinds of data such as image data and audio data.

The display unit 215 is configured with, for example, a liquid crystal display, an LED, or the like, and displays a GUI (Graphical User Interface), etc., for the user to operate the image processing apparatus 130. The operation unit 216 is configured with, for example, a keyboard, mouse, joystick, touchscreen, or the like, and inputs various kinds of instructions to the CPU 211 in response to operations by the user. The CPU 211 operates as a display controller that controls the display unit 215 and as an operation controller that controls the operation unit 216.

The communication unit 217 is used for communication with an external device of the image processing apparatus 130. For example, in a case where the image processing apparatus 130 is connected to an external device by wire, a cable for communication is connected to the communication unit 217. In a case where the image processing apparatus 130 has a function of performing wireless communication with an external device, the communication unit 217 includes an antenna. The bus 218 connects each unit of the image processing apparatus 130 for transmission of information.

Although the example in which the display unit 215 and the operation unit 216 are internally included in the image processing apparatus 130 will be explained in the present embodiment, it is also possible that at least one of the display unit 215 and the operation unit 216 is externally included as a device separated from the image processing apparatus 130. It is also possible that the display unit 215 and the operation unit 216 are integrated.

<Functional Configuration of Image Processing Apparatus>

A functional configuration example of the image processing apparatus 130 will be explained with reference to the drawings. FIG. 3 is a block diagram illustrating a functional configuration example of the image processing apparatus 130 included in the image processing system 300 of the present embodiment. As illustrated in FIG. 3, the image processing apparatus 130 includes the determination unit 301, the selection unit 302, the setting unit 303, the comparison unit 304, the rendering unit 305, and the operation unit 306. Each of these functional units is implemented by the CPU 211 in the above-described image processing apparatus 130 loading a predetermined program stored in the ROM 212 or the auxiliary storage device 214 into the RAM 213 and executing the program. Note that each functional unit of the image processing apparatus 130 may have a part of the functions of the other functional units. Hereinafter, each functional unit will be explained.

Based on the viewpoint information that is input from the input device 140, the determination unit 301 extracts a subject (dynamic object) from a rendering area, which is an output range of the virtual viewpoint image representing the perception from the virtual viewpoint, and determines a coloring-target pixel in an order in the extracted subject. The dynamic object is a foreground image of a captured image, and examples thereof include a person, ball, etc., included on the field.

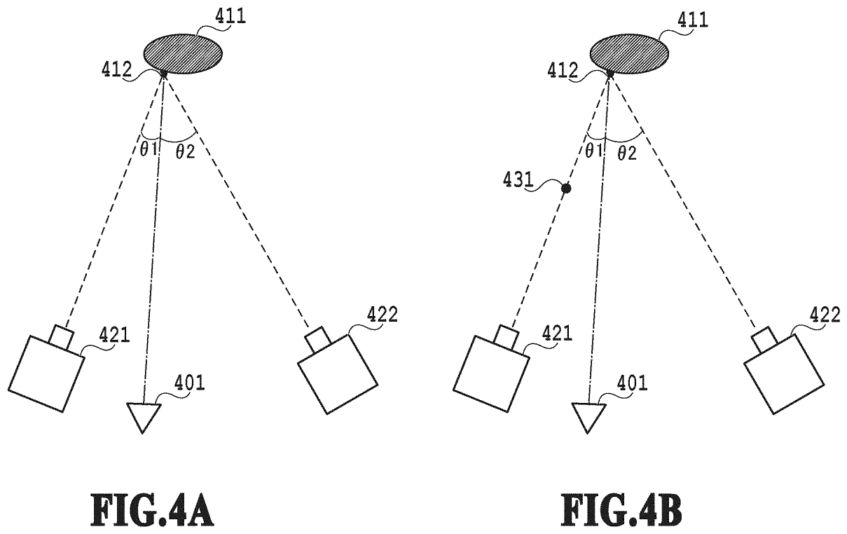

Here, the method for coloring a dynamic object at the time of generating a virtual viewpoint image by the above-described technology of Japanese Patent Laid-Open No. 2016-126425 will be explained with reference to the drawings. FIG. 4A and FIG. 4B are diagrams for explaining the relationship between an image capturing device, which is selected based on the information of a virtual viewpoint and a coloring-target pixel of a dynamic object, and a structure occluding the dynamic object in the image capturing direction of the image capturing device. The case in which there is no structure in the image capturing direction of the image capturing device is illustrated in FIG. 4A, and the case in which there is a structure in the image capturing direction of the image capturing device is illustrated in FIG. 4B. Note that a structure is not a dynamic object but a still object, which does not change its shape or move unless an external force caused by contact with a dynamic object, wind, etc., is applied, and the examples thereof include a soccer goal net or the like.

In a case of coloring the point 412 of the dynamic object 411 viewed from the virtual viewpoint 401, the angles formed by the vector from the virtual viewpoint 401 to the point 412 and the vectors from the image capturing devices 421 and 422 to the point 412 are assumed to be θ1 and θ2, respectively. In Japanese Patent Laid-Open No. 2016-126425, the coloring of the dynamic object 411 at the time of generating the virtual viewpoint image is performed with increase in the color weight of the image from the capturing device whose field of view is the closest to the field of view of the virtual viewpoint. Alternatively, as will be described in detail later, it is also possible that the selection unit 302 makes a redetermination by selecting a captured image that is obtained by capturing a dynamic object in advance in a state where a structure is not included in the image capturing area of an image capturing device.

The setting unit 303 obtains the color information that is designated by a user operation via the operation unit 306 and sets the obtained color information as prohibited color information (also referred to as rendering-prohibited color information) for prohibiting coloring on a dynamic object. Examples of the color information include the color information of a structure which is designated in a captured image of an image capturing device in which a dynamic object appears across the structure. For example, the structure is one that does not change its shape or move unless an external force is applied, such as a goal net, not a dynamic object, and cannot be set as a static object. A static object is a background other than a foreground, such as a goal on a field and spectators' seat. For example, from among multiple image capturing devices, the setting unit 303 obtains color information of a goal net from captured images of the image capturing devices 110f, 110g, 110n, and 110o which capture images of a soccer player across the goal net. As a method for obtaining color information, for example, it is also possible to use a method such as obtaining a pixel value of a goal net part from a captured image. Further, there are fluctuations in the pixel values to be obtained, depending on the appearance of the goal net. Therefore, it is also possible that pixel values of multiple goal net parts are respectively obtained from captured images of multiple image capturing devices, and the range of values from the minimum value to the maximum value of the respective colors is set as prohibited color information, so that a wide color range is thereby set as prohibited color information. Further, without being limited thereto, a determination may also be made based on the average value and variance of the obtained pixel values, and conversion into a uniform color space may also be performed for comparing the color difference.

In the captured image of the image capturing device that is selected by the selection unit 302, the comparison unit 304 compares the color information of the pixel (also referred to as the target pixel) corresponding to the coloring-target pixel of a dynamic object at the time of generating a virtual viewpoint image with the prohibited color information that is set by the setting unit 303. Next, in a case where it is determined that the color information of the target pixel is not included in the prohibited color information as a result of the comparison, the comparison unit 304 instructs the rendering unit 305 to perform rendering by use of the color information of the target pixel in the captured image of the selected image capturing device. In a case where it is determined that the color information of the target pixel is included in the prohibited color information as a result of the comparison, the comparison unit 304 instructs the selection unit 302 to select a captured image of another image capturing device that is different from the captured image of the previously-selected image capturing device. Further, in a case where it is determined that the color information of the target pixels in the captured images of all the selection-target image capturing devices is included in the prohibited color information, the comparison unit 304 may also perform such processing as shown below. That is, the comparison unit 304 may instruct the selection unit 302 to select the color information of the target pixel in the captured image of the image capturing device whose field of view is the closest to the field of view of the virtual viewpoint and transmit the color information to the comparison unit 304. Alternatively, the comparison unit 304 may instruct the selection unit 302 to transmit to the comparison unit 304 a captured image which is obtained by capturing an image of the dynamic object in advance with an image capturing device in a state where a structure is not included in the image capturing area of the image capturing device.

The rendering unit 305 performs coloring on a per pixel basis by use of the color information according to an instruction from the comparison unit 304, so as to correct the color of the pixels determined by the determination unit 301, based on the viewpoint information that is input from the input device 140. That is, the rendering unit 305 performs coloring on a dynamic object at the time of generating a virtual viewpoint image by use of the color information according to an instruction from the comparison unit 304. Information after the rendering is transmitted to the output device 150.

The operation unit 306 accepts a user operation for inputting setting information such as prohibited color information, etc., and transmits the accepted setting information to the setting unit 303.

<Processing Flow in Image Processing Apparatus>

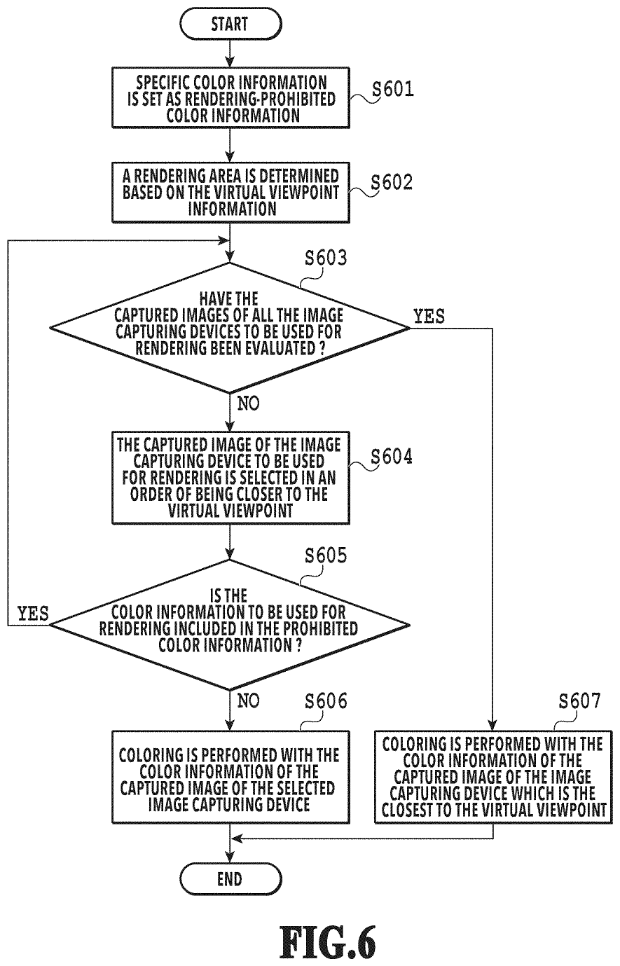

FIG. 6 is a flowchart illustrating a flow of the processing executed by the image processing system 300. The processing illustrated in FIG. 6 is performed by the CPU 211 reading out and executing a computer program stored in the ROM 212 or the auxiliary storage device 214. Hereinafter, a processing step is simply notated as S. In the present embodiment, a captured image of a soccer game will be taken as an example for the explanation.

In S601, the setting unit 303 sets specific color information as rendering-prohibited color information. The specific color information may be, for example, color information of a goal net or the like. The specific color information may be information that is input from the operation unit 306 by a user operation or may be information that is obtained from a captured image that is input from the image capturing device 110.

In S602, the determination unit 301 determines a coloring-target pixel in an order within a rendering area, which is an output range of a virtual viewpoint image, based on viewpoint information that is input by the input device 140.

In S603, regarding the coloring-target pixel of a dynamic object at the time of generating the virtual viewpoint image, the selection unit 302 determines whether or not image capturing device 421, whose angle is relatively small so that the image capturing direction is close to the virtual viewpoint 401, and decrease in the color weight of the image from the image capturing device 422, whose angle is relatively large and is far from the virtual viewpoint. Alternatively, the coloring of the dynamic object 411 is performed by use of the image from the image capturing device 421 whose angle is relatively small so that the image capturing direction is close to the virtual viewpoint 401.

As illustrated in FIG. 4A, in a case where there is no structure occluding the dynamic object 411 in the image capturing directions of the image capturing devices 421 and 422, the color information of the coloring-target pixel 412 of the dynamic object 411 can be obtained from the captured images obtained in image-capturing by the image capturing devices 421 and 422. However, as illustrated in FIG. 4B, in a case where there is the structure 431 occluding the dynamic object 411 in the image capturing direction of the image capturing device 421, it is not possible to obtain appropriate color information as described below. That is, even though an attempt is made to obtain the color information of the coloring-target pixel 412 of the dynamic object 411 from the captured image of the image capturing device 421, the coloring-target pixel 412 is occluded by the structure 431 in the image capturing direction of the image capturing device 421, and thus the color information of the structure 431 will be obtained. As a result, in a case of generating a virtual viewpoint image representing the scene viewed from the virtual viewpoint 401, the coloring-target pixel 412 of the dynamic object 411 will be undesirably colored by use of the color information of the structure 431.

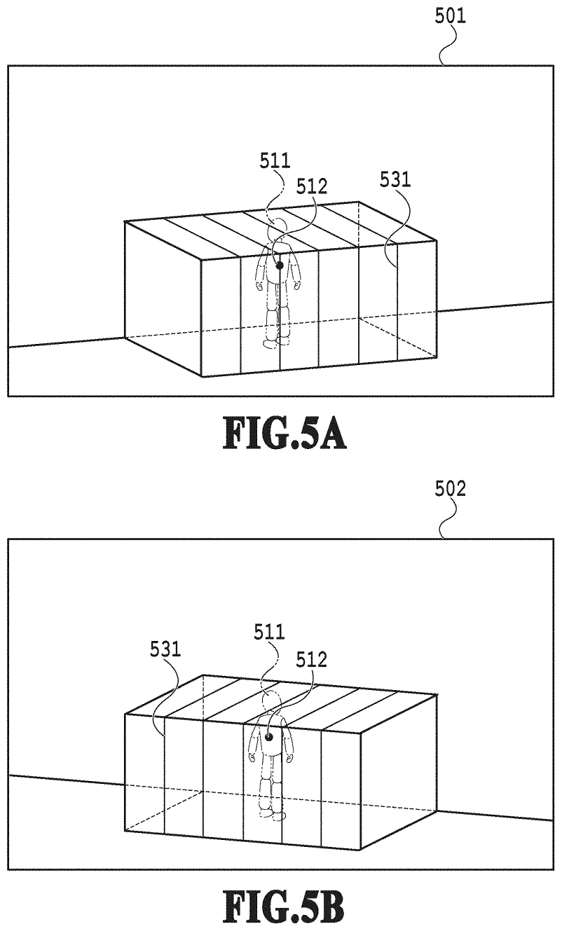

An explanation will be given of the case of coloring a goalkeeper at the time of generating a virtual viewpoint image by use of color information obtained from a captured image with the goalkeeper appearing across a soccer goal net. FIG. 5A and FIG. 5B are diagrams illustrating examples of a captured image from an image capturing device with a goalkeeper appearing across a goal net. The example of a captured image of the image capturing device 110g is illustrated in FIG. 5A, and the example of a captured image of the color information of the target pixels in the captured images of all the image capturing devices to be used for rendering has been evaluated. In a case of obtaining a result of determination that the color information of the target pixels of the captured images of all the image capturing devices has not been evaluated (NO in S603), the selection unit 302 proceeds the processing to S604, so that the captured image of the next image capturing device will be selected in S604 as described in detail later. On the other hand, in a case of obtaining a result of determination that the color information of the target pixels of the captured images of all the image capturing devices has been evaluated (YES in S603), the selection unit 302 proceeds the processing to S607.

In S604, based on the coloring-target pixel that is determined in S602, the viewpoint information, and a camera parameter of each image capturing device, the selection unit 302 selects another image capturing device that is different from the image capturing device that has been selected in an order from one whose field of view is closer to the field of view of the virtual viewpoint from among the captured images of the selection-target image capturing devices. Note that, in a case where none of the captured images of the image capturing devices to be used for rendering has been evaluated, the selection unit 302 selects the captured image of the image capturing device whose field of view is the closest to the field of view of the virtual viewpoint, based on the viewpoint information and a camera parameter of each image capturing device.

In S605, the comparison unit 304 determines whether or not the color information of the target pixel in the captured image of the image capturing device that is selected by the selection unit 302 is included in the prohibited color information that is set by the setting unit 303. In a case of obtaining a result of determination that the color information of the target pixel is included in the prohibited color information (YES in S605), the comparison unit 304 returns the processing to S603. In a case of obtaining a result of determination that the color information of the target pixel is not included in the prohibited color information (NO in S605), the comparison unit 304 proceeds the processing to S606.

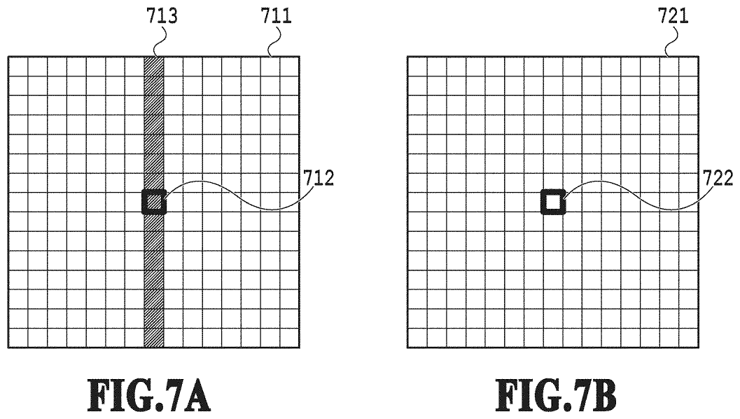

Here, a method for determining whether or not the color information of the target pixel is included in the prohibited color information will be explained with reference to the drawings. FIG. 7A and FIG. 7B are diagrams for explaining a method for determining whether or not the color information of the target pixel is included in the prohibited color information. The example in which the target pixel is occluded by a structure in the image capturing direction is illustrated in FIG. 7A, and the example in which the target pixel is not occluded by a structure in the image capturing direction is illustrated in FIG. 7B. In a part 711 of the captured image of the image capturing device 110g (FIG. 1) illustrated in FIG. 7A, the pixel (target pixel) 712 corresponding to the coloring-target pixel of a dynamic object at the time of generating a virtual viewpoint image is occluded by the pixels 713 which correspond to the goal net 531 (FIG. 5). In this case, the comparison unit 304 compares the color information of the pixels 713 of the goal net 531 with the prohibited color information and obtains a comparison result that the color information of the pixels 713 is included in the prohibited color information. On the other hand, in a part 721 of the captured image of the image capturing device 110f (FIG. 1) illustrated in FIG. 7B, the pixel (target pixel) 722 corresponding to the coloring-target pixel of a dynamic object at the time of generating a virtual viewpoint image is at a position that is not occluded by a goal net. In this case, the comparison unit 304 compares the color information of the pixel 722 of the dynamic object with the prohibited color information and obtains a comparison result that the color information of the pixel 722 is not included in the prohibited color information. In this way, the comparison unit 304 compares the color information of the target pixel in the captured image of each image capturing device corresponding to the coloring-target pixel with the prohibited color information, so that whether or not the color information of the target pixel is included in the prohibited color information is thereby determined.

Returning to FIG. 6, in S606, the rendering unit 305 performs coloring on the coloring-target pixel determined in S602 by use of the color information of the target pixel in the captured image of the image capturing device selected in S604.

In S607, the rendering unit 305 performs coloring on the coloring-target pixel determined in S602 by use of the color information of the target pixel in the captured image of the image capturing device whose field of view is the closest to the field of view of the virtual viewpoint. Accordingly, even though the color information of the target pixels corresponding to the coloring-target pixel, which are in the captured images of all the image capturing devices to be used for rendering, are included in the prohibited color information, the coloring can be performed by use of color information of the target pixel in the captured image of a relatively appropriate image capturing device.

As explained above, according to the present embodiment, coloring on a coloring-target pixel of a dynamic object at the time of generating a virtual viewpoint image can be performed by use of color information according to a result of determination as to whether or not the color information of a target pixel in the captured image of the selected image capturing device is included in the prohibited color information. That is, the color information of the object at the time of generating the virtual viewpoint image can be appropriately determined. Therefore, highlight scenes of soccer or basketball, for example, can be viewed from various angles, so that it is possible to give a user a highly realistic feeling, compared with normal video contents.

### Second Embodiment

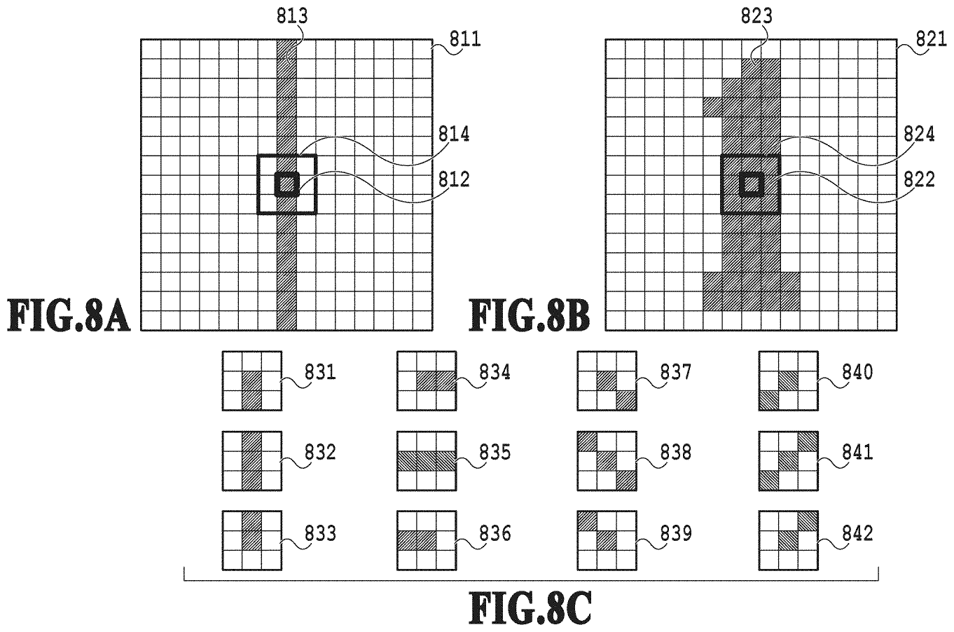

Next, as the second embodiment, an explanation will be given of the mode in which the color information of a unit area, which includes a target pixel and peripheral pixels thereof obtained from a captured image of an image capturing device, is compared with a prohibited color pattern in which a specific pixel and peripheral multiple pixels thereof have prohibited color information. FIG. 8A to FIG. 8C are diagrams for explaining a determination method using prohibited color patterns. An example of a partly-enlarged captured image of the image capturing device 110g (FIG. 1) is illustrated in FIG. 8A, an example of a partly-enlarged captured image of the image capturing device 110f (FIG. 1) is illustrated in FIG. 8B, and an example of prohibited color patterns is illustrated in FIG. 8C. It is indicated that the pixels with hatching have prohibited color information and the pixels without hatching (white pixels) have color information that is not included in the prohibited color information. Although, as with the first embodiment, the prohibited color information can be a value with a range in the present embodiment, the prohibited color information is represented by one color in FIG. 8A to FIG. 8C for simplification of the explanation.

It is assumed that the prohibited color patterns that are set by the setting unit 303 have been transmitted to the comparison unit 304 via the operation unit 306. In a case where a prohibited color pattern is a pattern of a unit area configured with 9 pixels of 3 by 3, for example, as illustrated in FIG. 8C, 12 patterns 831 to 833, 834 to 836, 837 to 839, and 840 to 842 are set. Specifically, these prohibited color patterns are configured so that at least the central pixel and any of the peripheral pixels that are adjacent to the central pixel in the vertical, horizontal, or diagonal directions in a unit area have prohibited color information and the other pixels have color information that is not included in the prohibited color information. Note that the prohibited color pattern is not limited to a square pattern that is configured with 9 pixels of 3 by 3 and may have other sizes or other shapes.

The comparison unit 304 determines whether or not the color information and the appearance pattern of the peripheral pixels including the target pixel corresponding to the coloring-target pixel of a dynamic object at the time of generating a virtual viewpoint image match any of the prohibited color patterns 831 to 842. In a case of obtaining a result of determination that is indicative of matching, the comparison unit 304 determines that the color information of the target pixel corresponding to the coloring-target pixel of the dynamic object at the time of generating the virtual viewpoint image is included in the prohibited color information.

In the captured image 811 (FIG. 8A) of the image capturing device 110g, the pixels 813 arranged linearly in the vertical direction are represented by the color of the goal net 531, and the other pixels are represented by colors that are not included in the color of the goal net 531. The unit pattern 814 which is configured with 9 pixels of 3 by 3, in which the target pixel 812 at the center corresponding to the coloring-target pixel of the dynamic object at the time of generating the virtual viewpoint image and the peripheral pixels thereof are included, matches the prohibited color pattern 832 of FIG. 8C. In a case where a unit pattern including the target pixel and peripheral pixels thereof matches a prohibited color pattern in this way, the comparison unit 304 determines that the color information of the target pixel 812 corresponding to the coloring-target pixel of the dynamic object at the time of generating the virtual viewpoint image is included in the prohibited color information. In a case where it is determined that the color information of the target pixel 812 is included in the prohibited color information, the captured image of the image capturing device that is a target for obtainment of the color information of the target pixel 812 will be excluded from the targets for obtainment of color information. Note that in a case where unit patterns including the color information of the target pixels and the peripheral pixels thereof in the captured images of all the obtainment-target image capturing devices match the prohibited color pattern, the following processing may be performed. That is, it is also possible to make a redetermination so that a captured image of an image capturing device excluded from the targets for obtainment of color information is selected as the captured image to be used for obtaining the color information of the object.

On the other hand, in the captured image 821 (FIG. 8B) of the image capturing device 110f, the pixels 823 corresponding to the shape of number 1 have a color representing the uniform jersey number of a soccer player and are represented with a color included in the color of the goal net 531. The other pixels are represented with colors that are not included in the color of the goal net 531. The unit pattern 824 which is configured with 9 pixels of 3 by 3, in which the target pixel 822 at the center corresponding to the coloring-target pixel of the dynamic object at the time of generating the virtual viewpoint image and the peripheral pixels thereof are included, does not match any of the prohibited color patterns 831 to 842 of FIG. 8C. In a case where a unit pattern including the color information of the target pixel and peripheral pixels thereof does not match prohibited color pattern in this way, the comparison unit 304 determines that the color information of the target pixel 822 corresponding to the coloring-target pixel of the dynamic object at the time of generating the virtual viewpoint image is not included in the prohibited color information. In a case where it is determined that the color information of the target pixel 822 is not included in the prohibited color information in this way, the color information of this target pixel 822 will be used for coloring the dynamic object at the time of generating the virtual viewpoint image.

As explained above, in a case where a unit pattern including the color information of the target pixel and peripheral pixels thereof matches a prohibited color pattern as in the captured image 811, the captured image that is the target for obtainment of the color information of the target pixel will be excluded from the captured images to be used for obtaining the color information of the dynamic object. Note that even though a unit pattern matches a prohibited color pattern, for example, in a case where the unit patterns of all the captured images to be the targets for obtainment of the color information of the dynamic object match prohibited color patterns, it is also possible that an excluded captured image is selected as the target for obtainment of the color information. On the other hand, in a case where a unit pattern including the color information of the target pixel and peripheral pixels thereof does not match prohibited color patterns as in the captured image 821, the captured image that is the target for obtainment of the color information of the target pixel will be selected. For example, even in a case where the color information of the uniform jersey number of a goalkeeper matches the color information of a goal net occluding the goalkeeper in a specific direction and the color information of the goal net happens to be set as prohibited color information, the coloring on the goalkeeper at the time of generating a virtual viewpoint image can be performed by use of the color information of the jersey number. Therefore, coloring on a dynamic object at the time of generating a virtual viewpoint image can be performed by use of relatively appropriate color information.

Note that the method for determining the color information of a coloring-target pixel is not limited to the method using a prohibited color pattern. It is also possible that, in a case where the area ratio of the area having prohibited color information in the area including the target pixel and peripheral pixels thereof which is a comparison-target becomes greater than a predetermined ratio (for example, 40%), it is determined that the color information of the area is not included in the prohibited color information. For example, it is also possible that, by designating the area ratio of a prohibited color with a user operation to the operation unit 306 in the image processing apparatus 130 of FIG. 3, the setting unit 303 outputs the information of the area ratio of the prohibited color to the comparison unit 304. In this case, for example, in a case where the result of determination of being included in the prohibited color information is obtained in S605 of FIG. 6 (YES in S605), the comparison unit 304 determines whether or not the area ratio of the prohibited color is equal to or greater than the predetermined ratio. It is also possible that, in a case of obtaining the result of determination that the area ratio of the prohibited color is equal to or greater than the predetermined ratio, the comparison unit 304 proceeds the processing to S606, and, in a case of obtaining the result of determination that the area ratio of the prohibited color is not equal to or greater than the predetermined ratio, the comparison unit 304 returns the processing to S603.

Furthermore, it is also possible to determine prohibited color patterns by machine learning or the like. For example, the setting unit 303 may set a learning result in the image processing apparatus 130 of FIG. 3. In this case, for example, in S601 of FIG. 6, the setting unit 303 may set the learning result as the prohibited color pattern.

### Third Embodiment

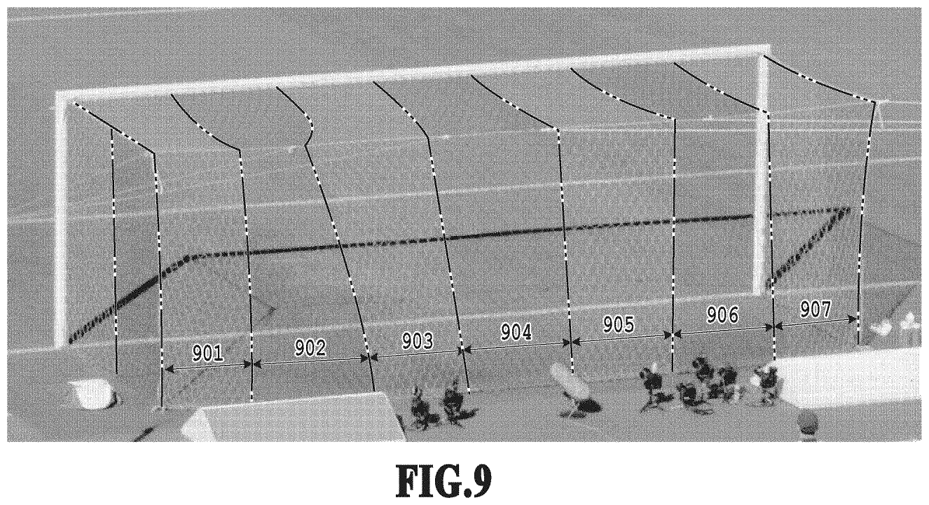

As the third embodiment, an explanation will be given of the mode in which the obtainment-position (pixel) of color information is compared with a prohibited area which is set based on an area having color information whose color difference from a dynamic object is relatively large so that the coloring on the dynamic object at the time of generating a virtual viewpoint image is performed by use of color information according to the comparison result. FIG. 9 is a diagram illustrating an example of a captured image with a structure partly having color information whose color difference from a dynamic object is relatively large, which is obtained in image-capturing by the image capturing device 110g. Note that, in FIG. 9, auxiliary lines are added in order to clarify the areas indicated by reference numerals 901 to 907. The soccer goal net is neither a dynamic object nor a static object but is a structure occluding a soccer player (dynamic object) in the image capturing direction of an image capturing device. Note that the goal net is in a shape having a ceiling part of which the front end is attached to the crossbar, a rear part which is connected to the rear end of the ceiling part, and side parts of which the front ends are connected to the goal posts, the upper ends are connected to the ceiling part, and the rear ends are connected to the rear part. The ceiling part is a part that covers the upper side of the space on the rear side of the goal posts, the rear part is a part that covers the rear side of the space on the rear side of the goal posts, and the side parts are parts that cover the sides of the space on the rear side of the goal posts. The goal net is configured with two colors, so as to have an area configured with color information whose color difference from the uniform of a soccer player is relatively large and an area configured with color information whose color difference from the uniform is relatively small. In the captured image illustrated in FIG. 9, the goal net has the areas 901, 903, 905, and 907 having color information whose color difference from the uniform of a soccer player is relatively large. Further, the goal net has the areas 902, 904, and 906 having color information whose color difference from the uniform of a soccer player is relatively small.

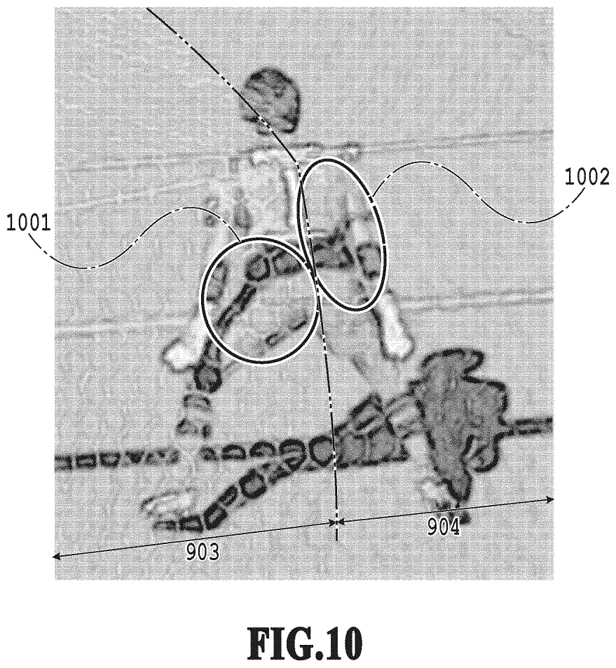

Here, with reference to the drawings, an explanation will be given of a method for obtaining color information from a captured image with a dynamic object appearing across a structure configured with an area having color information whose color difference from the dynamic object is relatively small and an area having color information whose color difference from the dynamic object is relatively large. FIG. 10 is a diagram illustrating an example of a captured image of an image capturing device in a case where a goal net having color information whose color difference from the uniform of a goalkeeper is relatively large occludes a part of the goalkeeper in the image capturing direction of the image capturing device.

In the captured image of the image capturing device illustrated in FIG. 10, the net part of each area is configured with the color information as follows. That is, the net part 1001 in the area 903 is configured with color information whose color difference from the uniform of the goalkeeper is relatively large, and the net part 1002 in the area 904 is configured with color information whose color difference from the uniform of the goalkeeper is relatively small. The information indicating the prohibited area in which the areas 901, 903, 905, and 907 having the color information whose color difference from the uniform of the goalkeeper is relatively large are set as the areas in which obtainment of color information to be used for coloring the goalkeeper at the time of generating a virtual viewpoint image is prohibited. In a case where the area in which obtainment of color information is prohibited is set by use of the generated prohibited area information, coloring on a dynamic object by use of the color information whose color difference from the uniform of the goalkeeper is a relatively large will be suppressed.

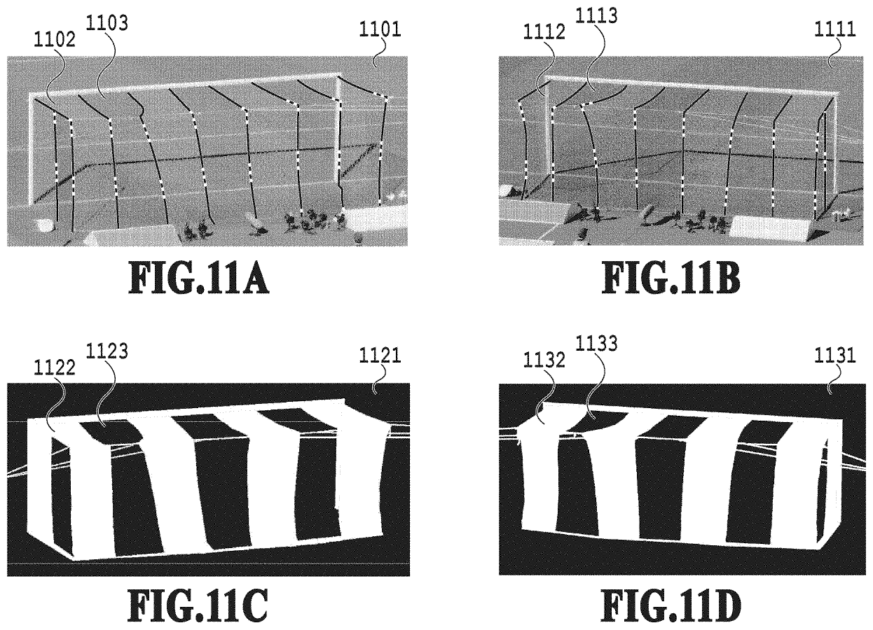

The processing for generating the prohibited area information will be explained with reference to the drawings. FIG. 11A to FIG. 11D are diagrams for explaining the processing of generating a mask image, which is prohibited area information. An example of a captured image of the image capturing device 110g is illustrated in FIG. 11A, an example of a captured image of the image capturing device 110f is illustrated in FIG. 11B, an example of the mask image corresponding to the captured image of FIG. 11A is illustrated in FIG. 11C, and an example of the mask image corresponding to the captured image of FIG. 11B is illustrated in FIG. 11D.

The goal nets of the captured image 1101 of the image capturing device 110g and the captured image 1111 of the image capturing device 110f are configured with two-tone colors. The goal nets of the captured images 1101 and 1111 have the areas 1102 and 1112 which are configured with color information whose color difference from the uniform of a soccer player is relatively large and the areas 1103 and 1113 which are configured with color information whose color difference from the uniform of a soccer player is relatively small. The areas 1102 and 1112 and the areas 1103 and 1113 are areas extending from the ceiling part to the rear part of the goal nets and are configured so as to be alternately arranged in the width direction of the soccer goals. Note that the side parts of the goal nets in the width direction of the soccer goals are also configured so that the areas 1102 and 1112 and the areas 1103 and 1113 are alternately arranged in the front-rear direction. Therefore, in the mask images 1121 and 1131, the areas 1122 and 1132 are illustrated in white, which represents the areas (hereinafter, also referred to as the “mask areas”) in which the color information thereof cannot be used for coloring a dynamic object at the time of generating a virtual viewpoint image. Further, in the mask images 1121 and 1131, the areas 1123 and 1133 are illustrated in black, which represents the areas in which the color information thereof can be used for coloring a dynamic object at the time of generating a virtual viewpoint image. Therefore, for the captured images 1101 and 1111, the mask images 1121 and 1131, in which the areas 1122 and 1132 are set as the areas in which the coloring on a dynamic object by use of the color information of the pixels therein at the time of generating a virtual viewpoint image is prohibited, will be generated.

<Functional Configuration of the Image Processing Apparatus>

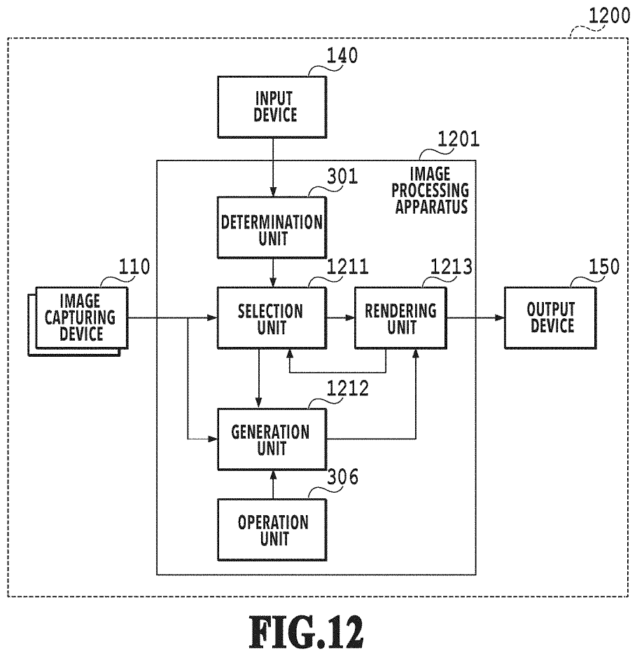

A functional configuration example of the image processing apparatus 1201 will be explained with reference to the drawings. FIG. 12 is a block diagram illustrating a functional configuration example of the image processing apparatus 1201 included in the image processing system 1200 of the present embodiment. As illustrated in FIG. 12, the image processing apparatus 1201 includes the determination unit 301, the operation unit 306, the selection unit 1211, the generation unit 1212, and the rendering unit 1213. Each of these functional units is implemented by the CPU 211 in the above-described image processing apparatus 130 loading a predetermined program stored in the ROM 212 or the auxiliary storage device 214 into the RAM 213 and executing the program. Note that the captured image obtained in image-capturing by the image capturing device 110 is transmitted to the selection unit 1211 and the generation unit 1212 of the image processing apparatus 1201 which will be described in detail later. Note that each functional unit of the image processing apparatus 1201 may have a part of the functions of the other functional units. Hereinafter, each functional unit will be explained.

In accordance with the later-described condition, the selection unit 1211 selects and determines a captured image of an image capturing device to be used for coloring a dynamic object at the time of generating a virtual viewpoint image from among captured images of multiple image capturing devices in which a coloring-target pixel determined by the determination unit 301 appears. The captured image of the image capturing device selected by the selection unit 1211 is transmitted to the rendering unit 1213. The selection unit 1211 instructs the generation unit 1212 to transmit to the rendering unit 1213 the mask image generated by the generation unit 1212 according to the captured image of the image capturing device that is transmitted to the rendering unit 1213. As with the selection unit 302, as a method for selecting a captured image of an image capturing device, for example, it is also possible to select a captured image of a specific image capturing device which is located within a predetermined range from the virtual viewpoint and whose field of view is the closest to the field of view of the virtual viewpoint.

Further, as will be described in detail later, it is also possible that the selection unit 1211 makes a redetermination by selecting a captured image of such an image capturing device as follows in accordance with an instruction from the rendering unit 1213. That is, it is also possible that the selection unit 1211 makes a redetermination by selecting a captured image of such an image capturing device as shown below in accordance with an instruction at the time where the rendering unit 1213 determines that the obtainment-position of the color information of a dynamic object in the captured images that is previously selected by the selection unit is included in a prohibited area. That is, it is also possible that the selection unit 1211 makes a redetermination to select the captured image of another image capturing device that is different from the previously-selected captured image in an order from one whose field of view is closer to the field of view of the virtual viewpoint. Further, it is also possible that the selection unit 1211 makes a redetermination by selecting a captured image of such an image capturing image as shown below in accordance with an instruction at the time where the rendering unit 1213 determines that the obtainment-positions of the color information of the dynamic objects in the captured images of all the image capture devices selected by the selection unit are included in a prohibited area. That is, it is also possible that the selection unit 1211 makes a redetermination by selecting the captured image of the image capturing device whose field of view is the closest to the field of view of the virtual viewpoint. Alternatively, as will be described in detail later, it is also possible that the selection unit 1211 makes a redetermination by selecting the captured image that is obtained by capturing an image of a dynamic object in advance in a state where a structure is not included in the image capturing area of an image capturing device.

The generation unit 1212 generates a mask image for each captured image that is input from an image capturing device 110. For example, in a case where the captured image 1101 illustrated in FIG. 11A is input, the generation unit 1212 generates the mask image 1121 illustrated in FIG. 11C corresponding to the captured image 1101. Further, in a case where the captured image 1111 illustrated in FIG. 11B is input, the generation unit 1212 generates the mask image 1131 illustrated in FIG. 11D corresponding to the captured image 1111. In the present embodiment, a mask image is generated by a user operation that is input from the operation unit 306 while referring to a captured image of an image capturing device 110. The generated mask image corresponding to the captured image of the image capturing device that is transmitted from the selection unit 1211 to the rendering unit 1213 is transmitted to the rendering unit 1213 in accordance with an instruction from the selection unit 1211.

To the captured image of the image capturing device selected by the selection unit 1211, the rendering unit 1213 applies the mask image generated by the generation unit 1212 for the captured image of this image capturing device, in order to perform the processing as follows according to the target pixel in the captured image of the image capturing device which is the target for obtainment of the color information. That is, in a case where the target pixel in the captured image of the image capturing device is not included in the mask area of the mask image, the rendering unit 1213 colors the dynamic object at the time of generating the virtual viewpoint image by use of the color information of the target pixel. On the other hand, in a case where the target pixel in the captured image of the image capturing device is included in the mask area of the mask image, the rendering unit 1213 cannot color the dynamic object at the time of generating the virtual viewpoint image by use of the color information of the target pixel. Therefore, as described above, the rendering unit 1213 instructs the selection unit 1211 to select a captured image of another image capturing device that is different from the captured image of the selected image capturing device. Such an instruction is conducted until it is determined that the target pixel in any of the captured images of all the selection-target image capturing devices is not included in the mask area of the mask image. In a case where it is determined that the target pixels in the captured images of all the selection-target image capturing devices are included in the mask area of the mask image, the rendering unit 1213 may perform the processing as shown below. That is, the rendering unit 1213 may instruct the selection unit 1211 to select the captured image of the image capturing device whose field of view is the closest to the field of view of the virtual viewpoint and to transmit the captured image to the rendering unit 1213. It is also possible that the rendering unit 1213 instructs the selection unit 1211 to obtain the color information of the dynamic object from the captured image which is obtained by capturing an image of the dynamic object in advance with an image capturing device in a state where no structure is included in the image capturing area of the image capturing device and to transmit the obtained color information to the rendering unit 1213.

<Processing Flow in Image Processing Apparatus>

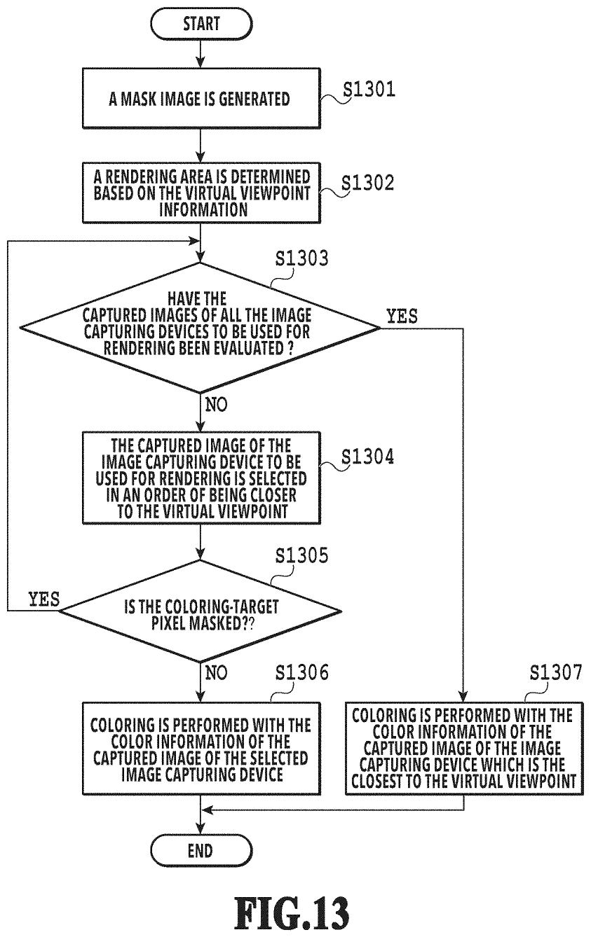

FIG. 13 is a flowchart illustrating a flow of processing executed by the image processing system 1200. The processing illustrated in FIG. 13 is performed by the CPU 211 reading out and executing a computer program stored in the ROM 212 or the auxiliary storage device 214.

In S1301, the generation unit 1212 generates a mask image for each captured image of the image capturing device that is input from the image capturing device 110. The generated mask image is transmitted to the rendering unit 1213 in accordance with an instruction from the selection unit 1211.

In S1302, the determination unit 301 determines the coloring-target pixel in an order within a rendering area, which is an output range of a virtual viewpoint image, based on viewpoint information that is input by the input device 140.

In S1303, regarding the coloring-target pixel of a dynamic object at the time of generating a virtual viewpoint image, the selection unit 1211 determines whether or not the color information of the target pixels of the captured images of all the image capturing devices to be used for rendering has been evaluated. In a case of obtaining a result of determination that the color information of the target pixels in the captured images of all the image capturing devices has not been evaluated (NO in S1303), the selection unit 1211 proceeds the processing to S1304, so that the captured image of the next image capturing device will be selected in S1304 as described in detail later. On the other hand, in a case of obtaining a result of determination that the color information of the target pixels in the captured images of all the image capturing devices has been evaluated (YES in S1303), the selection unit 1211 proceeds the processing to S1307.

In S1304, based on the coloring-target pixel that is determined in S1302, the viewpoint information, and a camera parameter of the image capturing device, the selection unit 1211 selects the captured image of another image capturing device that is different from the image capturing device that has been selected in an order from one whose field of view is closer to the field of view of the virtual viewpoint from among the captured images of the selection-target image capturing devices. Note that, in a case where none of the captured images of the image capturing devices to be used for rendering has been evaluated, the selection unit 1211 selects the captured image of the image capturing device whose field of view is the closest to the field of view of the virtual viewpoint, based on the viewpoint information and camera parameters of the image capturing devices.

In S1305, the rendering unit 1213 determines whether or not the target pixel corresponding to the coloring-target pixel in the captured image of the image capturing device selected by the selection unit 1211 is included in the mask area of the mask image generated by the generation unit 1212. In a case of obtaining a result of determination that the target pixel is included in the mask area (YES in S1305), the rendering unit 1213 returns the processing to S1303. In a case of obtaining a result of determination that the target pixel is not included in the mask area (NO in S1305), the rendering unit 1213 proceeds the processing to S1306.

By use of the captured image 1101 illustrated in FIG. 11A and the mask image 1121 illustrated in FIG. 11C, an explanation will be given of the relationship between the target pixel corresponding to the coloring-target pixel and the mask area. In a case where the target pixel corresponding to the coloring-target pixel is in the area 1102 of the captured image 1101, the rendering unit 1213 determines that the target pixel is included in the mask area 1122 of the mask image 1121. On the other hand, in a case where the target pixel corresponding to the coloring-target pixel is in the area 1103 of the captured image 1101, the rendering unit 1213 determines that the target pixel is included in the area 1123, which is not the mask area 1122 of the mask image 1121.

In S1306, the rendering unit 1213 performs coloring on the coloring-target pixel determined in S1302 by use of the color information of the target pixel in the captured image of the image capturing device selected in S1304.

In S1307, the rendering unit 1213 performs coloring on the coloring-target pixel determined in S1302 by use of the color information of the target pixel in the captured image of the image capturing device whose field of view is the closest to the field of view of the virtual viewpoint. Accordingly, even though the target pixels, which correspond to the coloring-target pixel, in the captured images of all the image capturing devices to be used for rendering are included in the mask area of the mask image, the coloring can be performed by use of color information of the target pixel in the captured image of a relatively appropriate image capturing device.

As explained above, according to the present embodiment, coloring on a coloring-target pixel of a dynamic object at the time of generating a virtual viewpoint image can be performed by use of the color information of a target pixel corresponding to a result of determination as to whether the target pixel in the captured image of the selected image capturing device is included in a prohibited area. That is, the color information of the object at the time of generating the virtual viewpoint image can be appropriately determined.

### Other Embodiments

Although the explanations have been given with the examples in which a net-like structure acts as an object occluding another object in the above-described embodiments on the assumption of generating a virtual viewpoint image in a case where a shooting scene or the like in a soccer game is viewed from the rear side of a goalkeeper, the present disclosure is not limited thereto. First, the above-described embodiments can be applied as it is to a competition in which a goal net is used as in soccer, such as a competition of handball, futsal, water polo, or the like. Further, the present embodiments can also be applied as it is to a competition in which an opponent is included across a net, such as a competition of volleyball, tennis, badminton, table tennis, or the like. Further, the above-described embodiments can also be applied as it is to a sport in which a protective net is used, such as baseball, a throwing event of athletics, or the like.

Although the cases of capturing an image of a soccer game are exemplified in the above-described embodiments, the image capturing target is not necessarily limited thereto. For example, the present embodiments can also be applied to image-capturing of other sports games such as rugby, tennis, ice skating, basketball, and karate, and performances and plays such as live performances and concerts.

In the first and second embodiments described above, it is also possible that post-processing such as smoothing is performed on the target pixel or the like after coloring is performed by use of the color information of the captured image of the other image capturing device. Accordingly, the target pixel can be adapted to the color around the target pixel.

In the first and second embodiments described above, in a case where the color information of the target pixel corresponding to the coloring-target pixel in the captured image of the image capturing device is included in the prohibited color information, such a way of coloring as follows may be performed. That is, the coloring may be performed with interpolation with the color information that is not included in the prohibited color information out of the color information of multiple pixels including the peripheral pixels of the target pixel corresponding to the coloring-target pixel in the captured image of a subject image capturing device.

It is also possible to combine the first embodiment and the third embodiment. It is possible to modify the processing so that S1303 to S1305 of FIG. 13 are added between NO in S605 and S606 of the flowchart of FIG. 6, and the processing proceeds to S607 in a case of YES in S1303 and the processing proceeds to S606 in a case of NO in S1305. Further, it is also possible to modify the processing so that S603 to S605 of FIG. 6 are added between NO in S1305 and S1306 of the flowchart of FIG. 13, and the processing proceeds to S1307 in a case of YES in S603 and the processing proceeds to S1306 in a case of NO in S605.

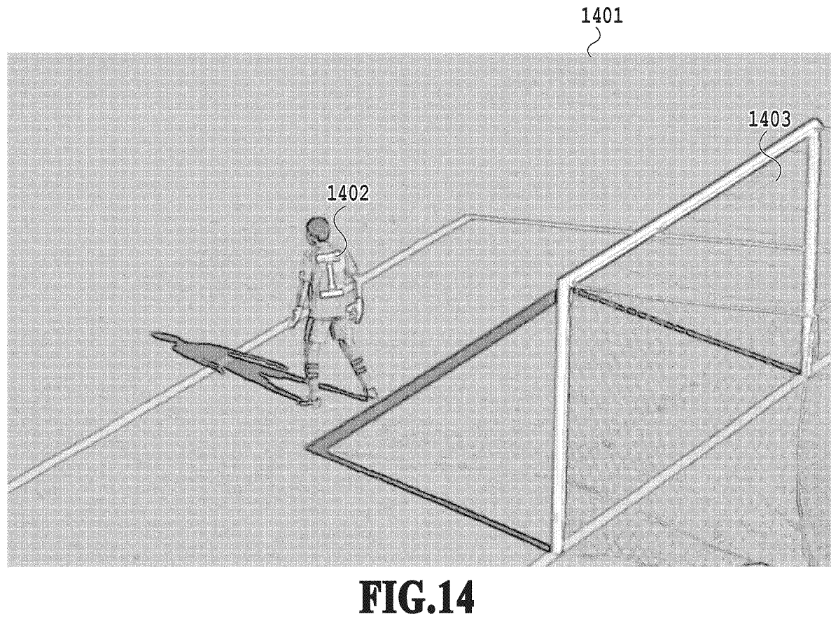

In the above-described embodiments, with preliminary learning of the captured image 1401 in which the goalkeeper 1402 is not occluded by the goal net 1403 in the image capturing direction of the image capturing device as illustrated in FIG. 14, it is also possible that the coloring at the time of the coloring process is performed by use of the color information of the target pixel in the image capturing image obtained by the learning.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Further, implementation in the mode below is also possible. That is, a computer program code which is read out from a storage medium is written to a memory included in a function expansion card inserted in a computer or a function expansion unit connected to a computer. Then, based on an instruction of the code of the computer program, the function expansion card, the CPU included in the function expansion unit, or the like performs a part or all of the actual processing in order to implement the above-described functions.

In a case where the present disclosure is applied to the above-described storage medium, the code of the computer program corresponding to the flowchart explained above is stored in the storage medium.

The present disclosure can be implemented by processing of supplying a program for implementing one or more functions of the above-described embodiments to a system or a device via a network or a storage medium, so that one or more processors in a computer of the system or the device read out and execute the program. Further, implementation by use of a circuit (for example, an ASIC) for implementing one or more functions is also possible.

According to the present embodiments, the color information of an object at the time of generating a virtual viewpoint image can be appropriately determined.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-130504, filed Jul. 31, 2020, which is hereby incorporated by reference wherein in its entirety.

What is claimed is:

1. An image processing apparatus comprising:
one or more memories storing instructions; and
one or more processors executing the instructions to:
specify a captured image to be used for obtaining color information of an object, based on a designated virtual viewpoint, from among a plurality of captured images obtained by a plurality of image capturing units that capture the object from different positions;
determine color information of the object in a virtual viewpoint image, based on the color information of the object obtained from the captured image specified in the specifying; and
generate the virtual viewpoint image, based on the color information of the object determined in the determining,
wherein, in the specifying, in a case where a structure occluding the object is included in the specified captured image, a captured image that is different from the specified captured image is specified as the captured image to be used for obtaining the color information of the object, based on color information of the structure.

2. The image processing apparatus according to claim 1,
wherein, in the specifying, a captured image corresponding to an image capturing unit having a field of view that is the closest to a field of view of the virtual viewpoint is specified as the captured image to be used for obtaining the color information of the object.

3. The image processing apparatus according to claim 2,
wherein, in the specifying, in a case where the color information of the object obtained from the specified captured image is included in prohibited color information, which is set based on the color information of the structure and is set for prohibiting coloring on the object, another captured image that is different from the specified captured image is selected in an order from a captured image of an image capturing unit having a field of view that is closer to the field of view of the virtual viewpoint, and, in a case where color information of the object obtained from the selected other captured image is not included in the prohibited color information, the selected other captured image is specified as the captured image to be used for obtaining the color information of the object.

4. The image processing apparatus according to claim 3,
wherein, in the specifying, in a case where all of the color information of the object obtained from the specified captured images are included in the prohibited color information, the captured image of the image capturing unit having the field of view that is the closest to the field of view of the virtual viewpoint is specified as the captured image to be used for obtaining the color information of the object.

5. The image processing apparatus according to claim 3,
wherein, in the specifying, in a case where all of the color information of the object obtained from the specified captured images are included in the prohibited color information, a captured image of the object in a state where the structure is not included in an image capturing area of the plurality of image capturing units is specified as the captured image to be used for obtaining the color information of the object.

6. The image processing apparatus according to claim 3,
wherein, of a target pixel and peripheral pixels thereof in a unit area, the prohibited color information is a pattern that is set for a plurality of pixels at least including the target pixel.

7. The image processing apparatus according to claim 2,
wherein, in the specifying, in a case where a position of obtaining the color information of the object in the specified captured image is included in a prohibited area, which is set based on an area having color information whose color difference from the object is relatively large within an area representing the structure and is set for prohibiting coloring on the object, another captured image that is different from the specified captured image is selected in an order from a captured image of an image capturing unit having a field of view that is closer to the field of view of the virtual viewpoint, and, in a case where a position of obtaining the color information of the object in the selected other captured image is not included in the prohibited area, the selected other captured image is specified as the captured image to be used for obtaining the color information of the object.

8. The image processing apparatus according to claim 7,
wherein, in the specifying, in a case where all positions of obtaining the color information of the object in the specified captured images are included in the prohibited area, the captured image of the image capturing unit having the field of view that is the closest to the field of view of the virtual viewpoint is specified as the captured image to be used for obtaining the color information of the object.

9. The image processing apparatus according to claim 7,
wherein, in the specifying, in a case where all positions of obtaining the color information of the object in the specified captured images are included in the prohibited area, a captured image of the object in a state where the structure is not included in an image capturing area of the plurality of image capturing units is specified as the captured image to be used for obtaining the color information of the object.

10. The image processing apparatus according to claim 2,
wherein, in the specifying, in a case where the color information of the object obtained from the specified captured image is included in prohibited color information, which is set based on the color information of the structure and is set for prohibiting coloring on the object, or in a case where a position of obtaining the color information of the object in the specified captured image is included in a prohibited area, which is set based on an area having color information whose color difference from the object is relatively large within an area representing the structure and is set for prohibiting coloring on the object, another captured image that is different from the specified captured image is selected in an order from a captured image of an image capturing unit having a field of view that is closer to the field of view of the virtual viewpoint, and, in a case where the color information of the object obtained from the selected other captured image is not included in the prohibited color information and a position of obtaining the color information of the object in the selected other captured image is not included in the prohibited area, the selected other captured image is specified as the captured image to be used for obtaining the color information of the object.

11. The image processing apparatus according to claim 10,
wherein, in the specifying, in a case where all of the color information of the object obtained from the specified captured images are included in the prohibited color information or in a case where all of the positions of obtaining the color information of the object in the specified captured images are included in the prohibited area, the captured image of the image capturing unit having the field of view that is the closest to the field of view of the virtual viewpoint is specified as the captured image to be used for obtaining the color information of the object.

12. The image processing apparatus according to claim 10,
wherein, in the specifying, in a case where all of the color information of the object obtained from the specified captured images are included in the prohibited color information or in a case where all of the positions of obtaining the color information of the object in the specified captured images are included in the prohibited area, a captured image of the object in a state where the structure is not included in an image capturing area of the plurality of image capturing units is specified as the captured image to be used for obtaining the color information of the object.

13. The image processing apparatus according to claim 1,
wherein the structure is in a shape of a net.

14. An image processing method comprising:
specifying a captured image to be used for obtaining color information of an object, based on a designated virtual viewpoint, from among a plurality of captured images obtained by a plurality of image capturing units that capture the object from different positions;
determining color information of the object in a virtual viewpoint image, based on the color information of the object obtained from the specified captured image; and
generating the virtual viewpoint image, based on the determined color information of the object,
wherein, in the specifying, in a case where a structure occluding the object is included in the specified captured image, a captured image that is different from the specified captured image is specified as the captured image to be used for obtaining the color information of the object, based on color information of the structure.

15. A non-transitory computer readable storage medium storing a program for causing a computer to execute an image processing method,
the image processing method comprising:
specifying a captured image to be used for obtaining color information of an object, based on a designated virtual viewpoint, from among a plurality of captured images obtained by a plurality of image capturing units that capture the object from different positions;
determining color information of the object in a virtual viewpoint image, based on the color information of the object obtained from the specified captured image; and
generating the virtual viewpoint image, based on the determined color information of the object,
wherein, in the specifying, in a case where a structure occluding the object is included in the specified captured image, a captured image that is different from the specified captured image is specified as the captured image to be used for obtaining the color information of the object, based on color information of the structure.
